(19) United States
(12) Patent Application Publication
(10) Pub. No.: US 2016/0084731 A1
(43) Pub. Date: Mar. 24, 2016

(54) ACOUSTIC TRANSDUCER APPARATUS AND METHOD OF USE

(71) Applicant: The Cleveland Electric Laboratories Company, Twinsburg, OH (US)

(72) Inventors: John J. Martin, Phoenix, AZ (US); Michael A. McNeilly, Gilbert, AZ (US)

(21) Appl. No.: 14/861,221

(22) Filed: Sep. 22, 2015

Related U.S. Application Data
(60) Provisional application No. 62/053,404, filed on Sep. 22, 2014.

(51) Int. Cl. G01M 3/24; G01H 9/00

(52) U.S. Cl. CPC G01M 3/243; G01H 9/004

(57) ABSTRACT

An acoustic transducer apparatus comprising a bolt; a second portion; a first portion; a cover; a nut; an entrant optical fiber for connecting to an external device; an optical splitter with an input fiber; and, an optical fiber that is configured as a loop with at least one winding about an axis; wherein the entrant optical fiber, optical splitter, and looped optical fiber are configured to perform as an optical interferometer, and are contained within a housing made up of the bolt, second portion, first portion, cover, and nut and an associated method of use of the acoustic transducer apparatus.

### TECHNICAL FIELD

The present invention relates to an apparatus for sensing acoustic phenomena in order to accurately quantify it as electronic data. More particularly, the present invention is directed at an optically-based acoustic transducer that uses optical interferometry to detect vibrations that are then analyzed and processed into data.

### BACKGROUND

Pipelines, such as underground pipelines that carry a liquid or a gas, are subject to typical issues such as obstructions or leaks. When such an issue occurs, it is critical to be able to detect the location of the problem so that it can be repaired as soon as possible. This is especially true for leaks in pipelines that carry hazardous or combustible material such as natural gas or oil. For example, if a natural gas or oil line were struck by a backhoe or a gunshot, there could be an immediate rupture in the line that would require emergency repairs to avoid a fire or explosion. Thus it is important to be able to quickly detect the location of the leak with great accuracy. A current solution for this type of detection, along with similar applications, is an array of electronic devices that can sense a disturbance along a pipe, rail, or other structure, and then transmit the data so the disturbance can be located. This type of detection has disadvantages in that the devices need to be powered, such as with a battery, and these batteries need to be maintained on a regular basis. In addition, these types of sensors are subject to electro-magnetic interference (EMI) from other electric devices such as power lines, etc. Finally, these types of sensors have a limited “visibility” in terms of their effective range.

What is needed is a sensing apparatus that can provide highly accurate sensing of acoustic phenomena, with immunity to EMI interference, low power consumption, reduced maintenance, and extended visibility.

### SUMMARY

Provided is an acoustic transducer apparatus comprising a bolt; a second portion; a first portion; a cover; a nut; an entrant optical fiber for connecting to an external device; an optical splitter with an input fiber; and, an optical fiber that is configured as a loop with at least one winding about an axis; wherein the entrant optical fiber, optical splitter, and looped optical fiber are configured to perform as an optical interferometer, and are contained within a housing made up of the bolt, second portion, first portion, cover, and nut.

Further provided is a method of detecting disruptions in the flow of material within a pipeline comprising the steps of:
a. Providing at least one acoustic transducer apparatus comprising a bolt; a second portion; a first portion; a cover; a nut; an entrant optical fiber for connecting to an external device; an optical splitter with an input fiber; an optical interrogator; and, an optical fiber that is configured as a loop with at least one winding about an axis; wherein the entrant optical fiber, optical splitter, and looped optical fiber are configured to perform as an optical interferometer, and are contained within a housing made up of the bolt, second portion, first portion, cover, and nut; wherein the at least one acoustic transducer apparatus is installed on a pipeline at a predetermined interval;
b. operating the pipeline in a known normal state;
c. electronically measuring and storing the acoustic signature of normal flow of material through the pipeline at a predetermined location using the at least one acoustic transducer, as the baseline measurement;
d. continuously and electronically measuring at a predetermined location using the at least one acoustic transducer and transmitting the acoustic signature of the flow of material through the pipeline to the optical interrogator;
e. comparing the electronically collected measurements to the predetermined baseline measurement; wherein deviations in the acoustic signature measurements indicate a disruption in the normal flow of material through the pipeline;
f. using time domain analysis of the measured acoustic signatures to determine the exact time and location of the disruption relative to the predetermined location of the at least one acoustic transducer.

### DESCRIPTION OF THE DRAWINGS

FIG. 1 is a side and cross-sectional view of the acoustic transducer

FIG. 2 is a plan view of the second portion of the acoustic transducer and the main cavity.

FIG. 3 is plan view of the first portion of the acoustic transducer and the fiber loop cavity.

FIG. 4 is a detailed cross-sectional view of the acoustic transducer.

FIG. 5 is a perspective view of the acoustic transducer and a schematic diagram of its connection to an optical interrogator.

FIG. 6 is an array of acoustic transducers and an optical interrogator.

### DETAILED DESCRIPTION

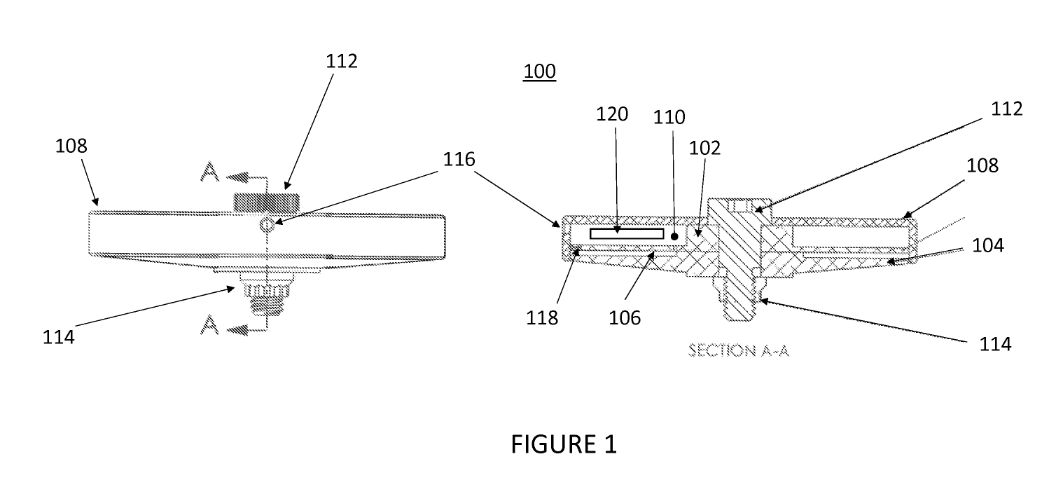

With reference to FIG. 1, a side view and cross sectional view of a first non-limiting embodiment of an acoustic transducer 100, which is based on the principle of optical interferometry, is shown wherein a first portion 104 can be connected to a second portion 102, which can therebetween form an optical fiber loop cavity 106. The second portion 102 and first portion 104 can be held together, along with the cover 108, by which a main cavity 110 can be formed, by bolt 112. The bolt 112 can secured by nut 114. Alternatively the bolt 112 and nut 114 can be any other type of fastener appropriate for the desired application, as chosen by a person of skill in the art. For example, and without limitation, the bolt 112 and nut 114 can be replaced with one or more other mechanical fasteners such as a pin, clip, or threaded insert, locking tab, or adhesives. Mechanical fasteners may be separate components or integrally molded into other components such as a round hole with female threading therein or a round projection with male threading thereon. The cover 108 can have an entry hole 116 through which one or more optical fibers can pass from the outside of the cover into main cavity 110. Second portion 102 can have an access hole 118 through which one or more optical fibers can pass from main cavity 110 into optical fiber loop cavity 106. Main cavity 110 can contain a two-into-two optical splitter 120.

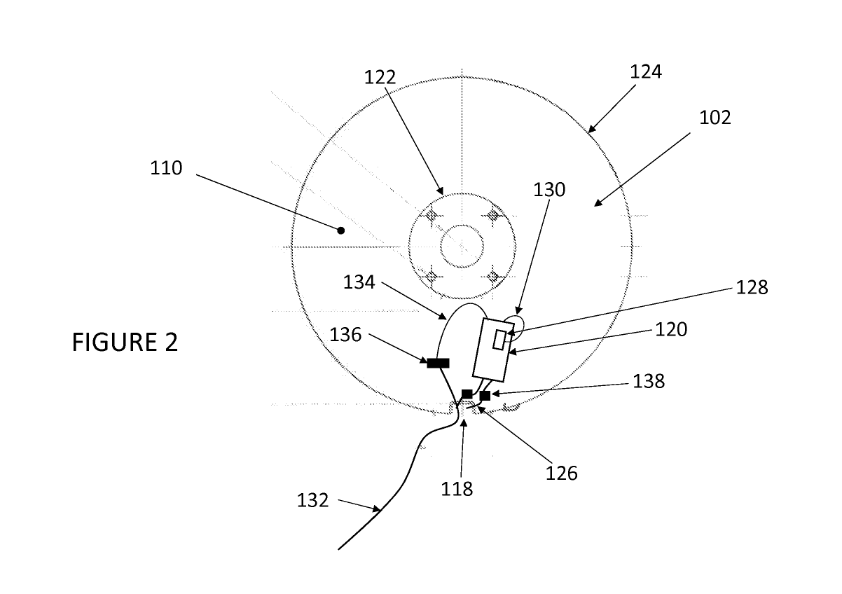

With reference to FIG. 2, a top view of the main cavity 110 is shown, which can be formed by second portion 102 and cover 108, and can extend from the inner radial edge 122 to the outer radial edge 124. The two-into-two optical splitter 120, which can be placed between the inner radial edge 122 and the outer radial edge 124, can have two ends, and can have two fibers connected to each end, for a total of four connections. The splitter 120 can connect from one end via fiber 130 to a dead end 128, which can be contained in the package of the splitter 120. A dead end is a type of optical terminator, which can be used to terminate unused connector ports in fiber optic components (such as the splitter 120) to eliminate unwanted reflections. Fiber 134, which can connect to the same end of splitter 120 as fiber 130, can be spliced to fiber 132 via connector 136, which can extend out of main cavity 110 through entry hole 116 (not shown). On the opposite end of the splitter 120 from the connections of fibers 130 and 134, the two ends of fiber loop 126 can be connected via splicing to the splitter by connector pair 138, whereby each end of the loop 126 is connected to a connection on the end of the splitter 120. The fibers of loop 126 can pass from the main cavity 110 through access hole 118 into the optical fiber loop cavity 106.

In an optical interferometer, light from a source is split into two beams that travel along their own individual paths and subsequently are recombined at a point or surface, at which location their wave-fronts either constructively or destructively interfere with each other and some net intensity results. The light originating from the source typically is monochromatic or of narrow spectral bandwidth. With continued reference to FIG. 2, fiber optic 132 can transmit light from a source into fiber 134 that can then be split into two beams by splitter 120 into loop 126, along which each beam can travel along their own individual paths.

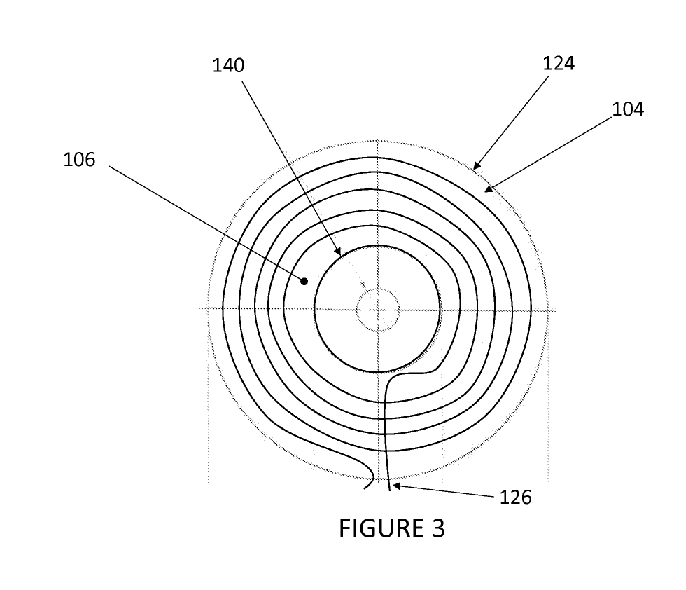

With reference to FIG. 3, a top view of the optical fiber loop cavity 106, can extend from the inner radial edge 140 to the outer radial edge 124. The inner radial edge 140 can act as a spool so that optical fiber loop 126 can be wound around it multiple times as shown. The fiber loop 126 can act as the path for the two optical signals that can enter it from the end of splitter 120. These optical signals can also exit from the loop 126 in the same manner but in reverse, i.e. they can return to the splitter 120 after traveling around the loop. The length of the loop 126 can be 100 meters, and the diameter of the fiber can be 1,550 nanometers. The light is moving very fast, and it does not take long for the light signals sharing the loop 126 to move through the loop. However if the loop 126 moves even slightly in an interferometer configured as a ring, such as from vibrations from acoustic energy, the length of the optical path traveled by one of the beams along loop 126 of light can slightly increase or decrease compared to the length of the other path while the movement is occurring; this can cause the phase of arrival of the wave-fronts of light to shift with respect to each other, and can thus cause the net intensity due to their interference at the point of recombination to vary. This net intensity can be measured electronically with a photodetector. Thus the splitter 120 can act as a beam splitter to input two light signals into the two ends of loop 126, and can also act to recombine the two signals and output the combined signal back through fiber 132. This is the principle behind ring laser gyroscopes (RLGs) and fiber optic gyroscopes (FOGs) which use an interferometer configured as a ring and that are employed for navigation purposes, and is also known as a single-fiber Sagnac Interferometer.

With continued reference to FIG. 3, according to this embodiment, the sensitivity of the acoustic transducer 100 to movement or acoustic excitation can be tailored by varying the number of turns and corresponding length of the fiber loop 126 on the spool as defined by inner radial edge 140. With increasing length of fiber loop 126, the sensitivity to movement or acoustic excitation can correspondingly increase; however, as fiber loop 126 increases, the package size and mass of the acoustic transducer assembly 100 can increase as well. The result can lead to a point where sensitivity to low-amplitude excitation at high frequencies decreases below a desirable level. Interferometric variations in intensity can be greatest for movements collinear with the optical fiber; thus the disc-like spool configuration is most sensitive to movements that are rotational with respect to the axis of symmetry. The axis of symmetry is coincident with section line A-A in FIG. 1. By winding the optical fiber in succession on multiple collocated spools mounted at defined angles with respect to each other, the sensitivity of the acoustic transducer 100 to movements in certain directions can be tailored or emphasized. Such directional sensitivity can be exploited to preferentially sense acoustic events or vibrational modes that occur in particular directions or planes in an object. By winding the optical fiber loop 126 in a continuously rotating orbital fashion to form a spherical shape, such that no rotational axis of symmetry is emphasized over any other, sensitivity can be made omnidirectional. Acoustic spectral sensitivity characteristics can be tailored as well by varying the configuration (solid or hollow) and/or the material of construction (and the associated density, mass and mechanical compliance) of the core on which the fiber loop 126 is wound.

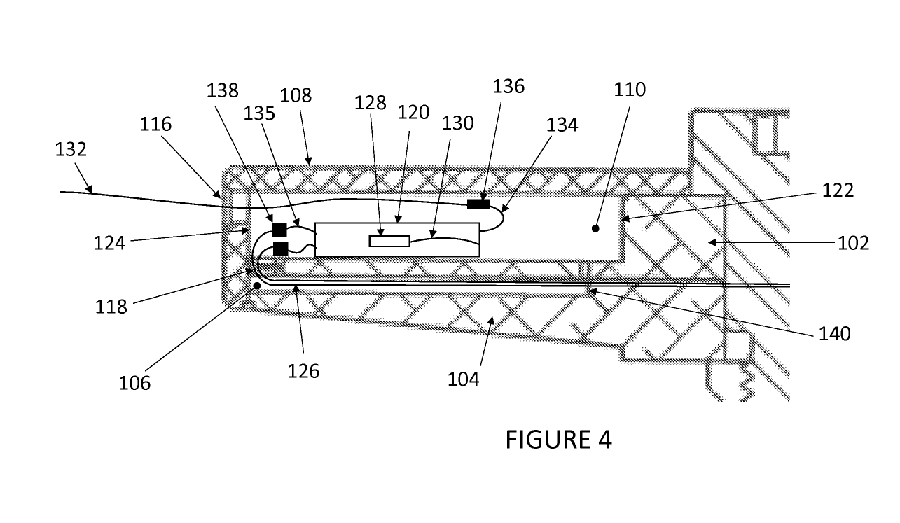

With reference to FIG. 4, according to this embodiment, a detailed cross-sectional view of the acoustic transducer shows fiber 132 can enter through the cover 108 via entry hole 116 into main cavity 110 and can be spliced via connector 136 to fiber 134, which is connected to one end of splitter 120. On the same end that fiber 134 is connected, fiber 130 can be connected and can further connect to dead end 128, which can be contained in the package of the splitter 120. On the opposite end of splitter 120 from fibers 130 and 134, the two ends of fiber pair 135 can be spliced to the fiber loop 126 via connector pair 138 which can then pass out of main cavity 110 through second portion 102 via access hole 118 into optical fiber loop cavity 106, where they can be wound around the inner radial edge 140 which can act as a spool for winding the loop 126. These fiber connections can be typically done as a fiber splice, which can be subsequently protected by a sleeve.

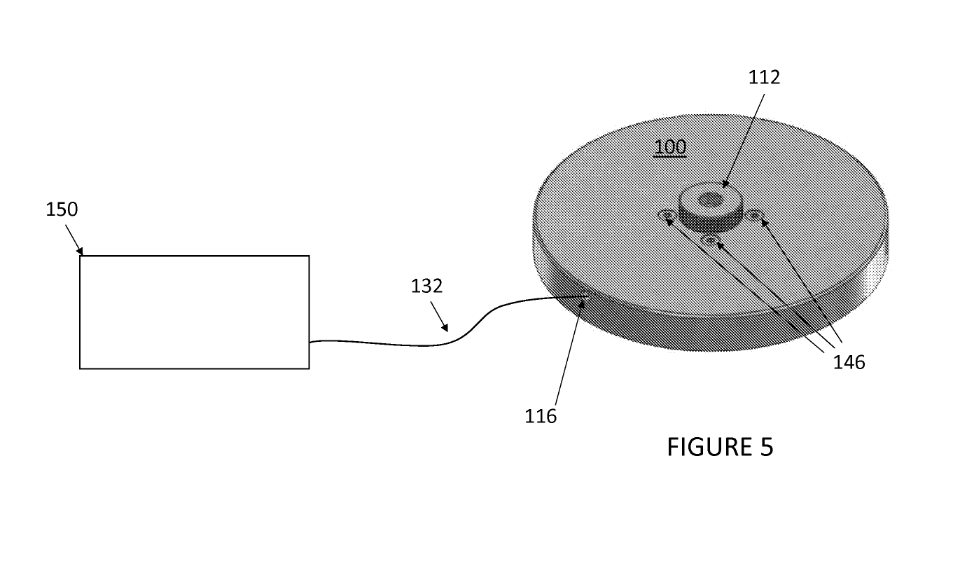

With reference to FIG. 5, according to this embodiment, the acoustic transducer 100, which can have screws 146 fastening the cover 108 to second portion 102, can be connected to an interrogator 150 by fiber 132, which can enter the acoustic transducer via entry hole 116. The interrogator 150 is a complex electro-optical device that can a) inject the optical signal (light) into the acoustic transducer via fiber 132, b) detect the recombined light that returns from the loop 126 after it has travelled around the loop and been recombined by splitter 120, and c) analyze and digitize the return light. With appropriate calibration, along with supporting electronics and software, the rate of change in movement of the individual optical path or paths in loop 126, and by extension the movement of the platform on which the optical interferometer is mounted, can be measured.

With reference to FIGS. 4 and 5, according to this embodiment, and as previously discussed, both the splitting and recombination of light can be performed by the fiber optic splitter 120 in a small cylindrical package that can be physically located in main cavity 110. This splitter 120 can typically be a two-into-two device but can also have only three fiber leads (wherein the fourth branch can be dead-ended into 128 within the package of the splitter 120, via fiber 130), the fiber 134 on one end connected to fiber 132 which is connected to the optical interrogator 150, and the two leads on the other end of the splitter 120 connected to the ends of the loop 126 via splicing to fiber pair 135; the functional result is that the fiber optic splitter 120 functions as a one-into-two splitter when viewing forward from the interrogator 150 into both ends of the fiber loop 126 in the acoustic transducer, and as a two-into-one combiner when viewing from both ends of the loop 126 back toward the interrogator 150. With this configuration only one optical fiber 132 is needed to convey light out and back between the interrogator 150 and a given acoustic transducer 100. Although the light can be both split and recombined locally in the acoustic transducer 100, interference can occur and its net intensity at any instant can be continuously detected in the interrogator 150, resulting in the interconnecting fiber 132 between interrogator 150 and acoustic transducer 100 being insensitive to movement.

The optical interrogator 150 used for acoustic sensing can support up to 16 individual acoustic transducers. Multiple light sources are used in the optical interrogator 150, the quantity depending on the optical power output of the light sources, the spectral bandwidth of the light sources, the quantity of acoustic transducers 100, the power losses in the acoustic transducers themselves, as well as the power losses in interconnecting fiber and splices attendant to them. Each light source may consist of one high-power emitter having an emission spectrum with a broad bandwidth of 100 nm or greater that is centered on a wavelength of approximately 1550 nm. Alternately, each light source may consist of multiple discrete emitters each of moderate power and having a narrow-band emission spectrum with their individual outputs combined into one optical fiber, in general a minimum quantity of four narrow-band emitters being used, each emitting at a different peak wavelength, the wavelength peaks being spaced at generally equal intervals ranging from 10 nm to 25 nm apart such that all peaks are distributed generally evenly across an overall spectrum that is at least 100 nm wide and centered on approximately 1550 nm. The spectral makeup of light provided by each source thus consists either of a broad continuum centered on 1550 nm and spanning 100 nm or greater, or a series of multiple narrow bands spaced at 10 nm to 25 nm intervals and distributed across the same overall band encompassed by the broad continuum. The output of one light source, if it is of sufficient power, may be split to support a group of several acoustic transducers 100 which, together with other groups of acoustic transducers 100 that are supported by their own light sources, make up the aggregate total of up to 16 acoustic transducers supported by the optical interrogator 150. If one light source is not of sufficient power to support several acoustic transducers, then one light source is provided to support each acoustic transducer 100.

Light returning to the optical interrogator 150 from each acoustic transducer 100 is fed into a wavelength division demultiplexer (WDDM) that functions as a multi-wavelength filter and which serves to separate the returning light into multiple narrow discrete wavelength outputs. When a broad continuum light source is used, the WDDM output wavelengths are chosen to fall within and be spaced at equal intervals across the emission spectrum of the broadband source; a quantity of eight outputs is common, although more or less than eight outputs with their relative intervals correspondingly adjusted may be employed. When the multiple narrow-band light source approach is used, the quantity of WDDM outputs is chosen to match the quantity of discrete narrow-band emitters (six narrow-band emitters equals six WDDM outputs, eight narrow-band emitters equals eight WDDM outputs, and so on), and the WDDM output wavelengths are selected so they match the emission wavelengths of the discrete narrow-band emitters. Each of the narrow-band outputs from the WDDM is fed to its own optical detector, one detector for each demultiplexed wavelength. Each optical detector thus receives light that is limited to only one narrow spectral band that is unique to that particular detector. Optical interferometry at each detector therefore is specific to a narrow spectral band unique to that detector.

Variations in temperature, movement and/or bending of optical fiber cause changing birefringent properties in the fiber, which in turn cause varying polarization of the light transmitted through the fiber. For a given wavelength of light, the contrast of the optical interferometry occurring at the detector varies as a function of the alignment of the polarization states of the returning counter-propagating wavefronts of that light. Changes in birefringence in the optical fiber therefore are manifested as varying contrast of the optical interference occurring at the detector. Sharp contrast is desirable for maximum sensitivity to physical excitation of the acoustic transducer, and the sharpest contrast for a given wavelength of light occurs when the polarization states for the returning counter-propagating wavefronts of that light are aligned parallel with each other at the detector; orthogonal polarization angles will cause the contrast to drop to zero, and intermediate angles will result in intermediate contrasts. Although the varying effects on polarization may be minor in a short length of fiber, the long length of fiber used in an acoustic transducer 100 results in cumulative effects that become significant. Therefore, variations in temperature, movement and/or bending of the optical fiber in an acoustic transducer 100 will cause notable variations in the interferometric contrast seen at the detector for a given wavelength of light.

Light of different wavelengths traveling through optical fiber experiences different phase shifts in polarization. The temperature and the positioning of the optical fiber also affect polarization of light differently for different wavelengths of light passing through the fiber. Therefore, at a given instant, the polarization states of the return light of one particular wavelength at the point of interference at one detector may be nearly orthogonal and result in the interferometric contrast at that wavelength being very low, which effectively renders a given acoustic transducer 100 nearly insensitive to movement where that wavelength is concerned; while at the same instant the polarization states of the return light of a different wavelength at a different detector may be favorably aligned and result in the contrast of the interference pattern at that wavelength being high, which renders the same acoustic transducer 100 highly sensitive to any movements where that different wavelength is concerned. Simultaneous interferometry at multiple wavelengths of light, e.g., interferometric wavelength diversity, thus will result in one or several wavelengths having favorably-aligned polarization states at the point the wavefronts optically interfere at their given detectors. Although temperature and other physical effects on the birefringence in the optical sensing fiber in an acoustic transducer 100 will cause the contrast of the optical interference to vary or drift over time across all detectors, those variances will occur at different times and rates for each of the different wavelengths used, and at any given time optical interferometry of adequate contrast will occur at one or more detectors. By use of suitable supporting circuitry in the optical interrogator 150, the contrast of the interferometry at all detectors may be continuously monitored and discriminated, and signals from one or several detectors at which high-contrast interferometry is occurring at any given instant may be automatically selected for further processing. This novel use of agile wavelength selection assures system sensitivity to acoustic transducer 100 excitation under all conditions.

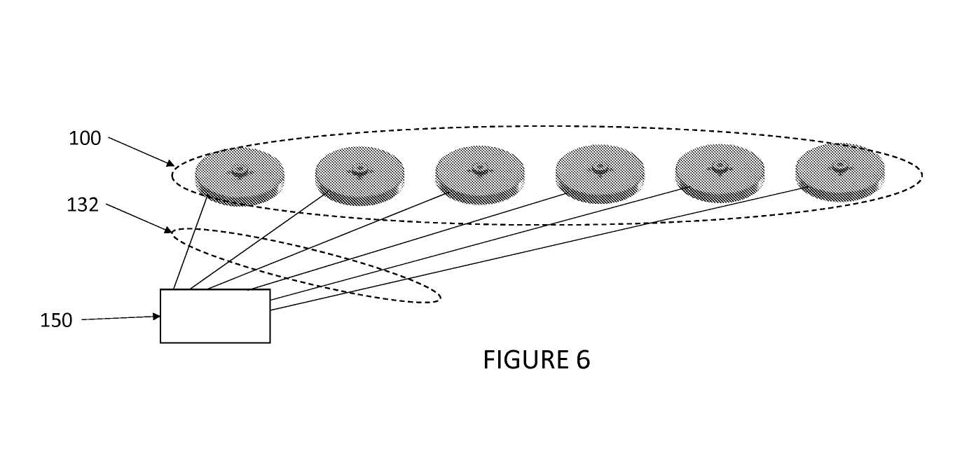

With reference to FIG. 6, according to this embodiment, one interrogator 150 will support multiple acoustic transducers 100, and because the interconnecting fiber 132 has very low optical loss, each of the acoustic transducers 100 may be tens of kilometers distant from the interrogator 150.

As initially discussed, this sensing system using acoustic transducers 100 and their associated interrogator 150 can be used to detect pipeline leaks, as well as flow monitoring. The flow of product carried in a pipeline will create vibration or an acoustic signature in that pipeline that are characteristic of the type of product (liquid or gas), its pressure and its flow rate. An array of acoustic transducers 100 may be installed on a pipeline at predetermined physical intervals along the length of the pipeline and used to sense or capture the acoustic signature of that pipeline. When the pipeline is operating in a known normal state, the acoustic signature is electronically captured and stored as a baseline. If the pipeline becomes obstructed or if a leak occurs, the product flow will be modified, causing the pipeline acoustic signature to change from its normal baseline characteristic. By continuous collection of acoustic signatures at all acoustic transducers 100 locations along the pipeline, and comparison of those signatures against the known-normal baseline for those locations, the flow and associated condition of the pipeline in any location may be remotely monitored and known in real-time. Sound travels through steel at a known velocity, so by use of time domain analysis of the acoustic signatures (e.g., time of flight) collected by acoustic transducers 100 installed at multiple known locations, the exact time and location of an impact or puncture event (such as caused by a gunshot or backhoe strike) at any point on the pipeline may be immediately determined. By analyzing the collected acoustic signature in the frequency domain and comparing it against the known good baseline, the nature of a leak event may be determined. Acoustic transducers 100 are advantageous over conventional electrically-based sensors for pipeline monitoring because they are passive, require no electrical power, and thus immune to noise, interference and degradation of signals even when deployed tens of kilometers from head-end equipment.

In addition to pipeline monitoring, there are many other applications where this system of acoustic transducers 100 and interrogator 150 can be used with their advantage of high sensitivity and long range visibility. An array of acoustic transducers 100 and interrogator 150 may be installed/deployed in areas of known geologic faults and used to sense and capture geoacoustic signatures, which potentially could improve advance warnings of major seismic events, thus possibly saving lives. In another application, tunneling requires earth removal, which unavoidably results in disturbances and subtle vibrations in the earth. An array of acoustic transducers 100 and interrogator 150 may be installed/deployed along borders or perimeters of protected property and used to sense and capture acoustic signatures associated with tunneling activities, thus helping protect borders and/or enhancing the physical security of sensitive facilities.

Other applications can include remote machinery monitoring, and bridge structural health monitoring using the same advantages as described above. Shafts, gears, bearings, reciprocating parts, or other moving components in machinery typically are under tensile or compressive loads depending on their location and function. Likewise, bridges have natural vibrational modes and resonant frequencies. Under normal operating conditions such machinery or structures may be said to naturally “sing” at various acoustic frequencies in response to loading excitation; in other words, its complex acoustic signature may be expressed as a power spectral density in the frequency domain. An array of acoustic transducers 100 and interrogator 150 may be used to monitor the machinery and or bridges from a long distance. In each of these applications, the acoustic transducer 100 may be configured to suit the frequency spectrum of interest, and the interrogator 150 sampling rate may be set to exceed the Nyquist limit such that fidelity of movement or vibration signature waveforms is assured.

In some embodiments the optic fiber 132 can be armored or otherwise mechanically protected for one or several meters length.

One non-limiting method of interferometry uses multiple wavelengths of light simultaneously, for example and without limitation, interferometric wavelength diversity, to result in one or several wavelengths having favorably-aligned polarization states at the point the wavefronts optically interfere in the interrogator, regardless of ambient environmental conditions existing at the transducers. A method of interferometry using multiple wavelengths of light simultaneously using wavelength diversity may include providing a light source in the interrogator, providing a means of separating the light returning to the interrogator from any given transducer into multiple narrow bandwidths mutually exclusive to one another, thereby allowing the intensity or contrast of the interferometric pattern that occurs at each mutually exclusive wavelength to be continually and separately detected; and providing suitable supporting circuitry in the optical interrogator, by which means the contrast of the interferometry at all detectors may be continuously monitored and discriminated, and by which signals from one or several detectors at which high-contrast interferometry is occurring at any given instant may be automatically selected for further processing.

The light source in the interrogator may comprise one high-power emitter having an emission spectrum with a broad bandwidth of 100 nm or greater that is centered on a wavelength of approximately 1550 nm, or a set of multiple discrete emitters each of moderate power and having a narrow-band emission spectrum, with their individual outputs combined into one optical fiber, in general a minimum quantity of four narrow-band emitters being used, each emitting at a different peak wavelength, the wavelength peaks being spaced at generally equal intervals ranging from 10 nm to 25 nm apart such that all peaks are distributed generally evenly across an overall spectrum that is at least 100 nm wide and centered on approximately 1550 nm. The spectral makeup of light provided by the source thus consists either of a broad continuum centered on 1550 nm and spanning 100 nm or greater, or a series of multiple narrow bands spaced at 10 nm to 25 nm intervals and distributed across the same overall band encompassed by the broad continuum. The output of one light source, if it is of sufficient power, may be split to support a group of several acoustic transducers which, together with other groups of acoustic transducers that are supported by their own light sources, make up the aggregate total maximum quantity of acoustic transducers that the optical interrogator is capable of supporting. If one light source is not of sufficient power to support several acoustic transducers, then one light source is provided to support each acoustic transducer.

A means of separating the light returning to the interrogator from any given transducer into multiple narrow bandwidths mutually exclusive to one another may comprise, for each transducer, a wavelength division demultiplexer (WDDM) that functions as a multi-wavelength filter and which serves to receive and separate the returning light that is input to the WDDM into multiple narrow wavelength outputs that are mutually exclusive; and a quantity of optical detectors in the interrogator is provided that matches the quantity of WDDM outputs, one detector thus being provided for each demultiplexed wavelength. For a configuration where a broad continuum light source is used, as described above, the WDDM may be configured to have a quantity of outputs having peak wavelengths that fall within and are spaced at equal intervals across the emission spectrum of the broadband source; a quantity of eight outputs is common, although more or less than eight outputs with their relative intervals correspondingly adjusted may be employed. For the configuration where the multiple narrow-band light source approach is used, as described above, the WDDM is configured to have a quantity of outputs matching the quantity of discrete narrow-band emitters (six narrow-band emitters equals six WDDM outputs, eight narrow-band emitters equals eight WDDM outputs, and so on), and the WDDM is configured so the output wavelengths match the emission wavelengths of the discrete narrow-band emitters, one for one. Each of the narrow-band outputs from the WDDM, being at a wavelength having a peak that is mutually exclusive to the peak wavelengths of any and all other outputs from that WDDM, is fed to one optical detector. Each optical detector thus receives light that is limited to only one narrow spectral band that is unique to that particular detector. Optical interferometry at each detector therefore is specific to a narrow spectral band unique to that detector.

What is claimed is:

1. An acoustic transducer apparatus comprising:
a. a bolt;
b. a second portion;
c. a first portion;
d. a cover;
e. a nut;
f. an entrant optical fiber for connecting to an external device;
g. an optical splitter with an input fiber; and,
h. an optical fiber that is configured as a loop with at least one winding about an axis;
wherein said entrant optical fiber, said optical splitter, and said looped optical fiber are configured to perform as an optical interferometer, and are contained within a housing comprising said bolt, said second portion, said first portion, said cover, and said nut.

2. The acoustic transducer of claim 1 wherein the housing can be attached to a structure or object of interest such that it can detect movements or vibrations of said structure or object by conveying movement or vibration in said structure or object of interest to said optical fiber winding; and, wherein said housing also serves as a physically robust package that accommodates mounting hardware thereby allowing it to be mechanically mounted to said moving or vibrating structure or object of interest.

3. The acoustic transducer of claim 1 wherein said optical splitter, for light input on the entrant optical fiber, splits the light equally between two output fibers on the opposite end of said splitter, and said splitter also functions in reverse by combining light input on said two output fibers and outputting it on said entrant optical fiber.

4. The acoustic transducer of claim 1 wherein the orientation, size, shape or density of said loop can be configured to maximize sensitivity of motion in a preferred axis or direction, or can be configured to have omnidirectional sensitivity.

5. The acoustic transducer of claim 1 further comprising an optical interrogator.

6. The acoustic transducer of claim 5 wherein said acoustic transducer and said optical interrogator are operable to utilize light of substantially one wavelength.

7. The acoustic transducer of claim 5 wherein said optical interrogator can be connected to it such that optical signals can be sent from said interrogator to the transducer, subsequently detected by the interrogator, and then processed by the interrogator such that measurements of physical phenomena can be determined from them.

8. The acoustic transducer of claim 1 wherein the configuration is such that it is sensitive to an extremely wide range of audio frequencies.

9. The acoustic transducer of claim 1 wherein said entrant fiber can be armored or otherwise mechanically protected for one or several meters length, the proximal end of which is located within the transducer housing.

10. The acoustic transducer of claim 9 wherein said armored or otherwise mechanically protected entrant optical fiber exits the housing, with its distal end serving to connect the transducer to a remote optical interrogator.

11. The acoustic transducer of claim 1 wherein said optical fibers are affixed in place with a potting material whereby individual turns in said optical fiber winding are physically bonded to other adjacent turns and prevented from freely moving or vibrating on their own accord.

12. The acoustic transducer of claim 1 wherein multiple transducers can be used in an array.

13. An acoustic transducer apparatus comprising:
a. a bolt;
b. a second portion;
c. a first portion;
d. a cover;
e. a nut;
f. an entrant optical fiber for connecting to an external device;
g. an optical splitter with an input fiber;
h. an optical fiber that is configured as a loop with at least one winding about an axis; and,
i. an optical interrogator;
wherein said entrant optical fiber, said optical splitter, and said looped optical fiber are configured to perform as an optical interferometer, and are contained within a housing comprising said bolt, said second portion, said first portion, said cover, and said nut.

14. The acoustic transducer of claim 13 wherein said acoustic transducer and said optical interrogator are operable to utilize light of more than one wavelength, the one or several wavelengths used at any given time being advantageously chosen to achieve optical interferometry of adequate contrast, and attendant sensitivity of the transducer to physical excitation, regardless of ambient environmental conditions.

15. The acoustic transducer of claim 13 wherein the housing can be attached to a structure or object of interest such that it can detect movements or vibrations of said structure or object by conveying movement or vibration in said structure or object of interest to said optical fiber winding; and, wherein said housing also serves as a physically robust package that accommodates mounting hardware thereby allowing it to be mechanically mounted to said moving or vibrating structure or object of interest.

16. The acoustic transducer of claim 13 wherein multiple transducers can be used in an array.

17. The acoustic transducer of claim 13 wherein the configuration is such that it is sensitive to an extremely wide range of audio frequencies.

18. The acoustic transducer of claim 13 wherein said optical interrogator can be connected to it such that optical signals can be sent from said interrogator to the transducer, subsequently detected by the interrogator, and then processed by the interrogator such that measurements of physical phenomena can be determined from them.

19. A method of detecting disruptions in the flow of material within a pipeline comprising the steps of:
a. Providing at least one acoustic transducer apparatus comprising:
i. a bolt;
ii. a second portion;
iii. a first portion;
iv. a cover;
v. a nut;
vi. an entrant optical fiber for connecting to an external device;
vii. an optical splitter with an input fiber;
viii. an optical fiber that is configured as a loop with at least one winding about an axis; and,
ix. an optical interrogator;
wherein said entrant optical fiber, said optical splitter, and said looped optical fiber are configured to perform as an optical interferometer, and are contained within a housing comprising said bolt, said second portion, said first portion, said cover, and said nut;
wherein said at least one acoustic transducer apparatus is installed on said pipeline at a predetermined interval;
b. operating the pipeline in a known normal state;
c. electronically measuring and storing the acoustic signature of normal flow of material through the pipeline at a predetermined location using the at least one acoustic transducer, as the baseline measurement;
d. continuously and electronically measuring at a predetermined location using the at least one acoustic transducer and transmitting the acoustic signature of the flow of material through the pipeline to the optical interrogator;
e. comparing the electronically collected measurements to the predetermined baseline measurement; wherein deviations in the acoustic signature measurements indicate a disruption in the flow of material through the pipeline;
f. using time domain analysis of the measured acoustic signatures to determine the exact time and location of the disruption relative to the predetermined location of the at least one acoustic transducer.
